(19) United States
(12) Patent Application Publication
(10) Pub. No.: US 2024/0184516 A1
(43) Pub. Date: Jun. 6, 2024

(54) NAVIGATING AND COMPLETING WEB FORMS USING AUDIO

(71) Applicant: Capital One Services, LLC, McLean, VA (US)

(72) Inventors: Selen BERKMAN, Richmond, VA (US); Yifan XU, Newton, MA (US); Duy HUYNH, Sterling, VA (US); Wade RANCE, Washington, DC (US); Ayushi CHAUHAN, Arlington, VA (US); KanakaRavali PERISETLA, Scottsdale, AZ (US); Amrit KHADKA, Henrico, VA (US); Morgan FREIBERG, Hamilton, VA (US)

(21) Appl. No.: 18/062,415

(22) Filed: Dec. 6, 2022

(51) Int. Cl. G06F 3/16; G06F 40/174; G10L 15/22; G10L 15/26

(52) U.S. Cl. CPC G06F 3/167; G06F 40/174; G10L 15/22; G10L 15/26; G10L 2015/223

(57) ABSTRACT

In some implementations, a user device may generate, using a text-to-speech library of a web browser, a first audio signal based on a first label associated with a first input element of a web form. The user device may generate, using a speech-to-text library of the web browser, a first transcription of first audio and may modify the first input element based on the first transcription. The user device may generate, using the text-to-speech library, a second audio signal based on a second label associated with a second input element of the web form. The user device may generate, using the speech-to-text library, a second transcription of second audio and may modify the second input element based on the second transcription. The user device may receive input associated with submitting the web form and may activate a submission element of the web form based on the input.

### BACKGROUND

Users with visual impairments often rely on sound to interact with computers. For example, word processors may provide transcription of spoken audio for visually impaired users.

### SUMMARY

Some implementations described herein relate to a system for navigating and completing a web form using audio. The system may include one or more memories and one or more processors communicatively coupled to the one or more memories. The one or more processors may be configured to receive input to trigger audio navigation of a web form loaded by a web browser, wherein the web form comprises hypertext markup language (HTML) code. The one or more processors may be configured to generate, using a text-to-speech library of the web browser, a first audio signal based on a first label indicated in the HTML code and associated with a first input element of the web form. The one or more processors may be configured to record first audio after generating the first audio signal. The one or more processors may be configured to generate, using a speech-to-text library of the web browser, a first transcription of the first audio. The one or more processors may be configured to modify the first input element of the web form based on the first transcription. The one or more processors may be configured to generate, using the text-to-speech library of the web browser, a second audio signal based on a second label indicated in the HTML code and associated with a second input element of the web form. The one or more processors may be configured to record second audio after generating the second audio signal. The one or more processors may be configured to generate, using the speech-to-text library of the web browser, a second transcription of the second audio. The one or more processors may be configured to modify the second input element of the web form based on the second transcription. The one or more processors may be configured to generate, using the text-to-speech library of the web browser, a third audio signal based on a submission button indicated in the HTML code. The one or more processors may be configured to record third audio after generating the third audio signal. The one or more processors may be configured to generate, using the speech-to-text library of the web browser, a third transcription of the third audio. The one or more processors may be configured to activate the submission button of the web form based on the third transcription.

Some implementations described herein relate to a method of navigating and completing a web form using audio. The method may include generating, by a user device and using a text-to-speech library of a web browser, a first audio signal based on a first label associated with a first input element of a web form. The method may include generating, by the user device and using a speech-to-text library of the web browser, a first transcription of first audio recorded after the first audio signal is played. The method may include modifying the first input element of the web form based on the first transcription. The method may include generating, by the user device and using the text-to-speech library of the web browser, a second audio signal based on a second label associated with a second input element of the web form. The method may include generating, by the user device and using the speech-to-text library of the web browser, a second transcription of second audio recorded after the second audio signal is played. The method may include modifying the second input element of the web form based on the second transcription. The method may include receiving, at the user device, input associated with submitting the web form. The method may include activating a submission element of the web form based on the input.

Some implementations described herein relate to a non-transitory computer-readable medium that stores a set of instructions for navigating and completing a web form using audio for a device. The set of instructions, when executed by one or more processors of the device, may cause the device to generate, using a text-to-speech library of a web browser, a first audio signal based on a label associated with an input element of a web form. The set of instructions, when executed by one or more processors of the device, may cause the device to generate, using a speech-to-text library of the web browser, a first transcription of first audio recorded after the first audio signal is played. The set of instructions, when executed by one or more processors of the device, may cause the device to modify the input element of the web form based on the first transcription. The set of instructions, when executed by one or more processors of the device, may cause the device to generate, using a speech-to-text library of the web browser, a second transcription of second audio recorded after modifying the input element. The set of instructions, when executed by one or more processors of the device, may cause the device to repeat the first audio signal based on the second transcription being associated with a backward command. The set of instructions, when executed by one or more processors of the device, may cause the device to generate, using the speech-to-text library of the web browser, a third transcription of third audio recorded after the first audio signal is repeated. The set of instructions, when executed by one or more processors of the device, may cause the device to re-modify the input element of the web form based on the third transcription.

### BRIEF DESCRIPTION OF THE DRAWINGS

FIGS. 1A-1J are diagrams of an example implementation relating to completing web forms using audio, in accordance with some embodiments of the present disclosure.

FIGS. 2A-2B are diagrams of an example implementation relating to navigating web forms using audio, in accordance with some embodiments of the present disclosure.

FIGS. 3A-3D are diagrams of an example implementation relating to navigating web forms using audio, in accordance with some embodiments of the present disclosure.

FIGS. 4A-4B are diagrams of an example implementation relating to navigating web forms using audio, in accordance with some embodiments of the present disclosure.

FIG. 5 is a diagram of an example environment in which systems and/or methods described herein may be implemented, in accordance with some embodiments of the present disclosure.

FIG. 6 is a diagram of example components of one or more devices of FIG. 5, in accordance with some embodiments of the present disclosure.

FIG. 7 is a flowchart of an example process relating to navigating and completing web forms using audio, in accordance with some embodiments of the present disclosure.

### DETAILED DESCRIPTION

The following detailed description of example implementations refers to the accompanying drawings. The same reference numbers in different drawings may identify the same or similar elements.

Visually impaired users may use screen readers in order to receive information that is typically presented visually. For example, a screen reader may be an independent application executed over an operating system (OS) of a user device, such as a smartphone, a laptop computer, or a desktop computer. Screen readers may execute in parallel with applications that are presenting information visually; for example, a screen reader may execute in parallel with a web browser in order to generate audio signals based on webpages loaded by the web browser. Therefore, screen readers may have high overhead (e.g., consuming power, processing resources, and memory).

Additionally, screen readers often read (or describe) large portions of webpages that are superfluous. For example, many webpages include menus and fine print, among other examples, that human readers would skip but that screen readers do not. As a result, screen readers waste additional power, processing resources, and memory.

Some implementations described herein provide for an application (e.g., a plugin to a web browser) that harnesses a text-to-speech library and a speech-to-text library of a web browser in order to facilitate interaction for visually impaired users. Using the libraries of the web browser conserves power, processing resources, and memory that external screen readers would otherwise consume. Additionally, the application may use hypertext markup language (HTML) and/or cascading style sheets (CSS) to readily identify relevant portions of a web form to convert to audio signals. As a result, the application further conserves power, processing resources, and memory that external screen readers would otherwise consume in reading superfluous information.

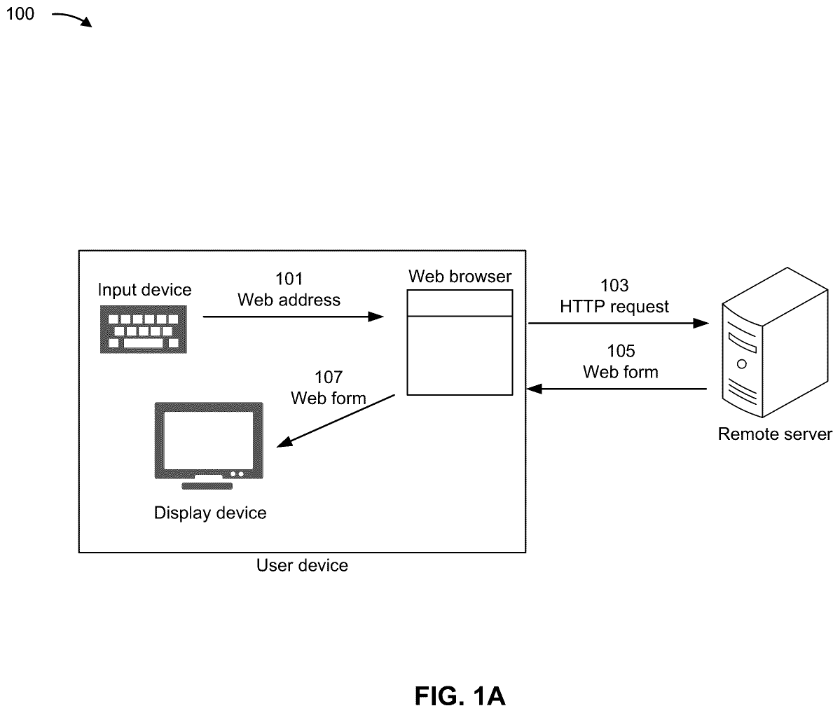

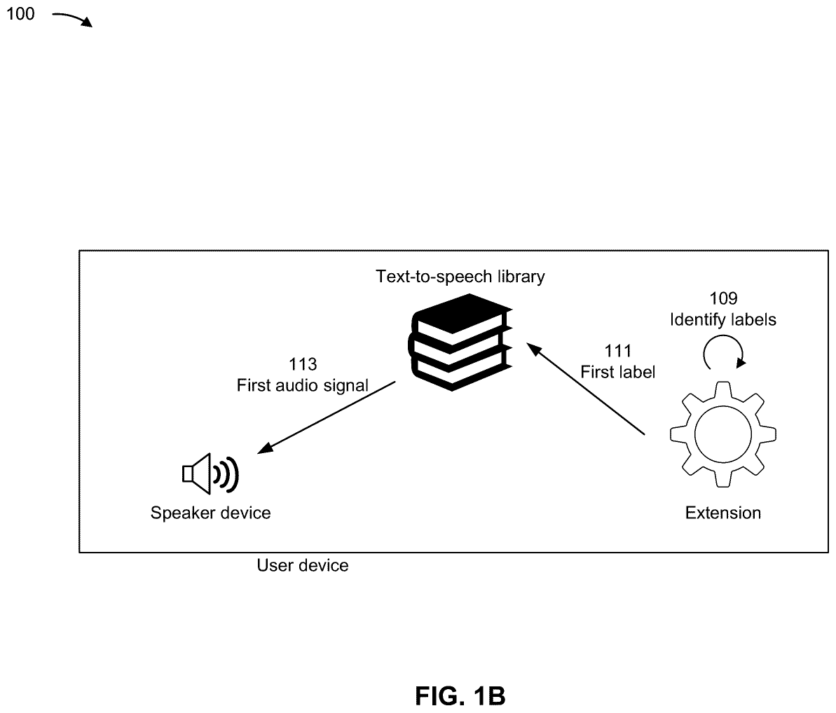

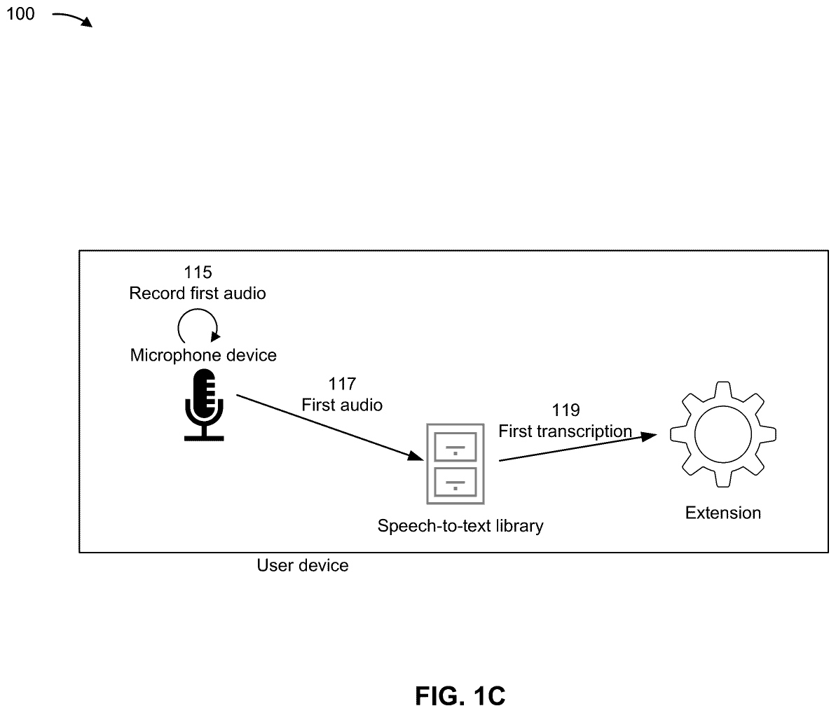

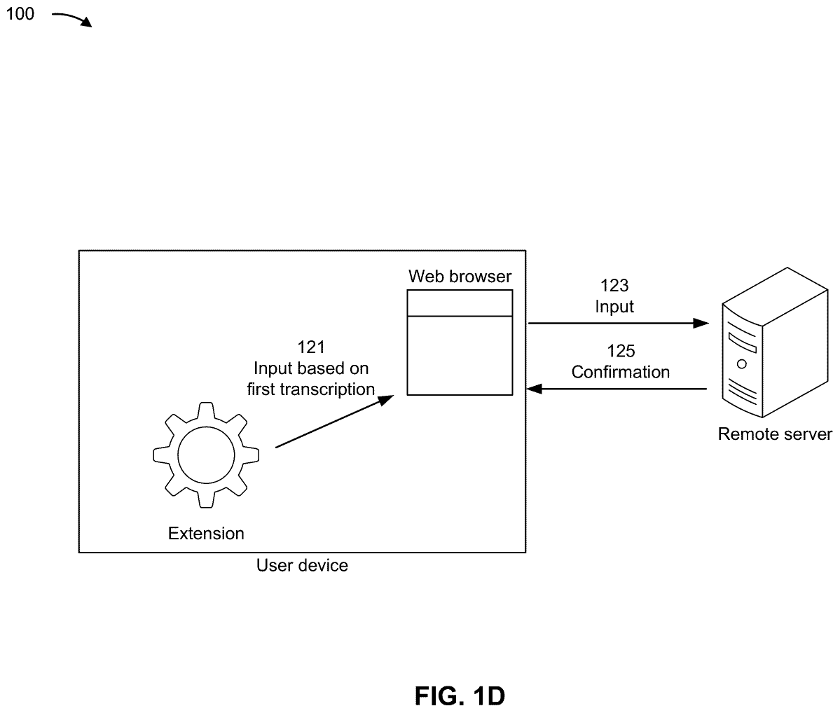

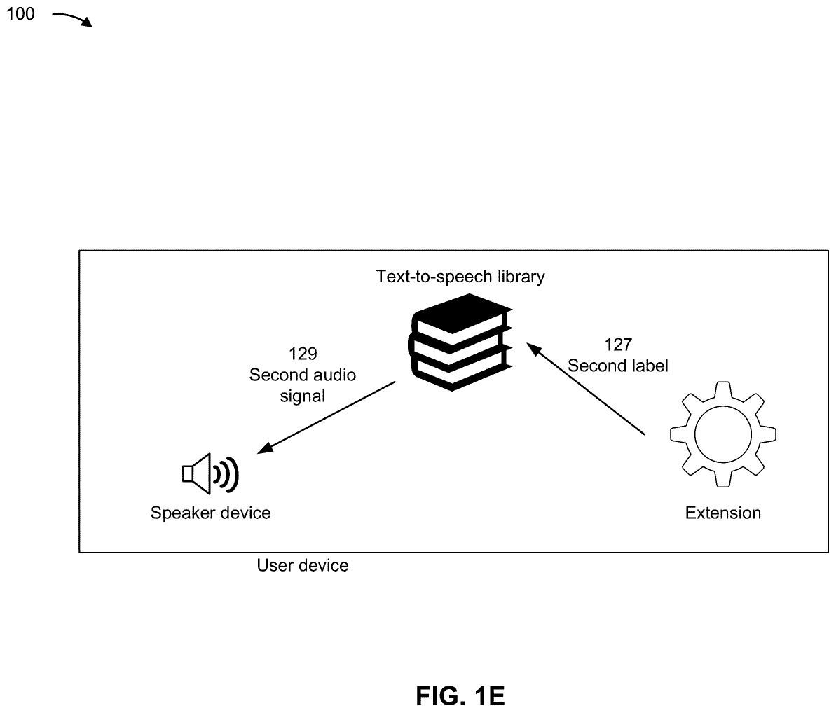

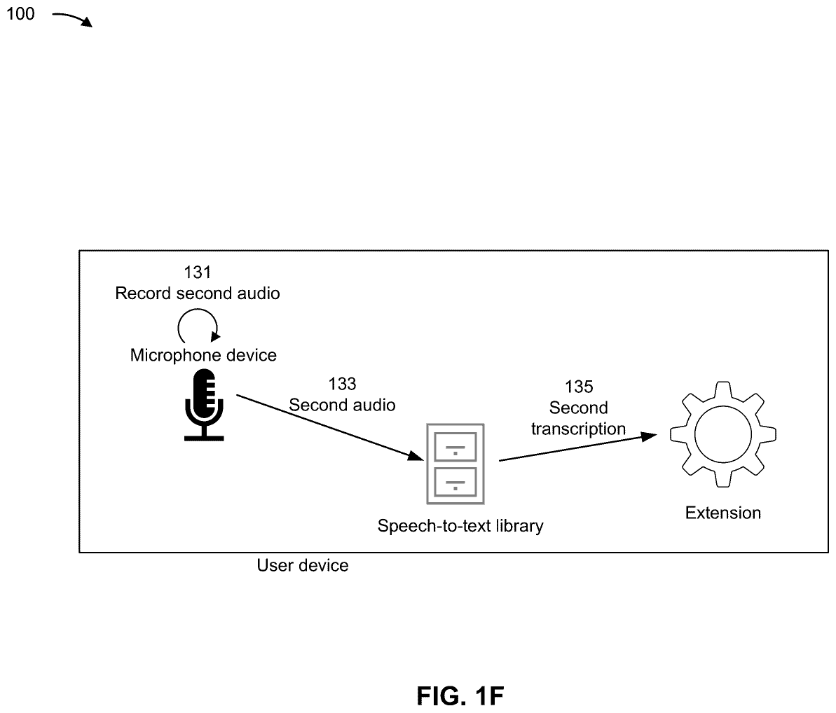

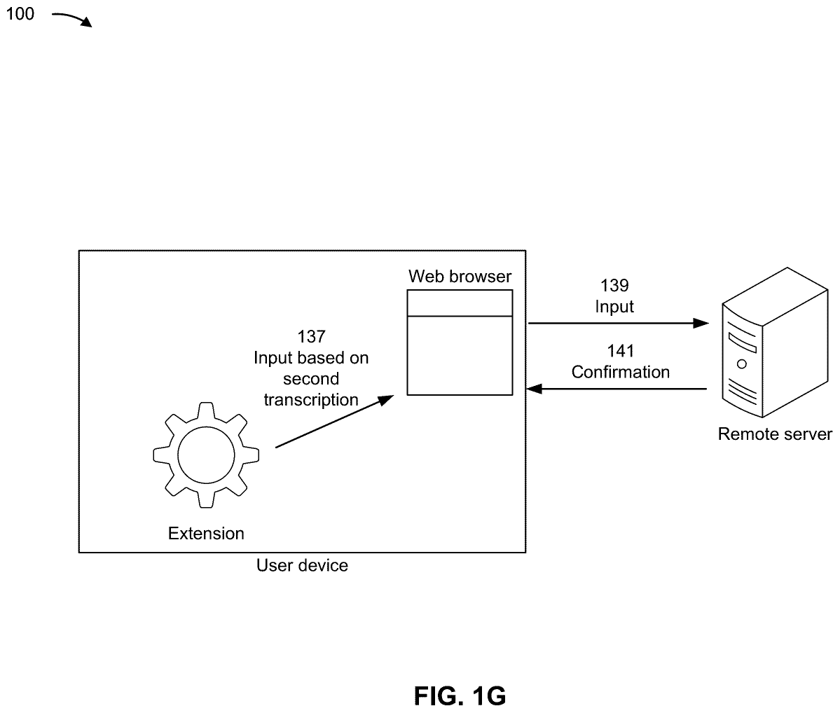

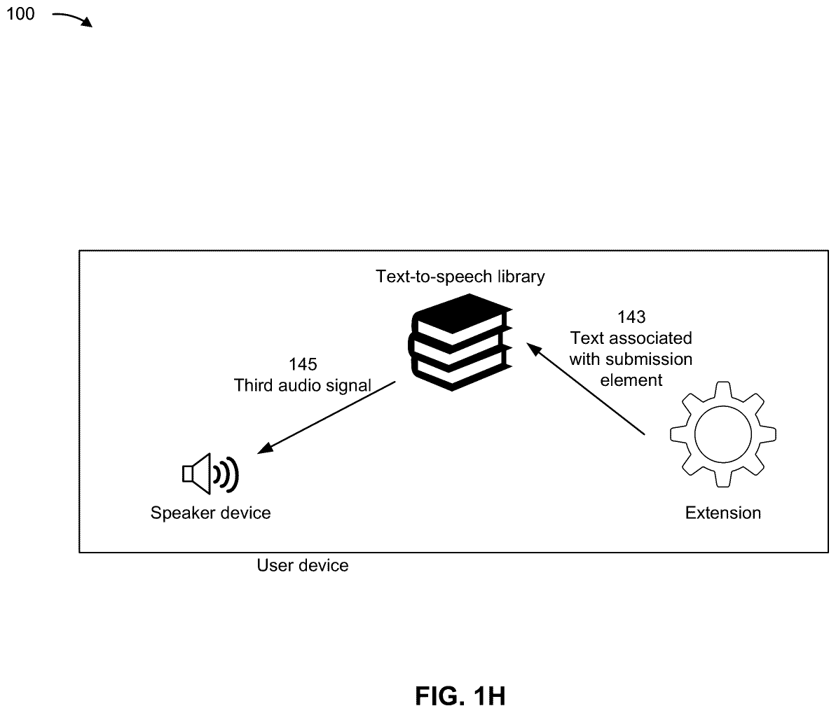

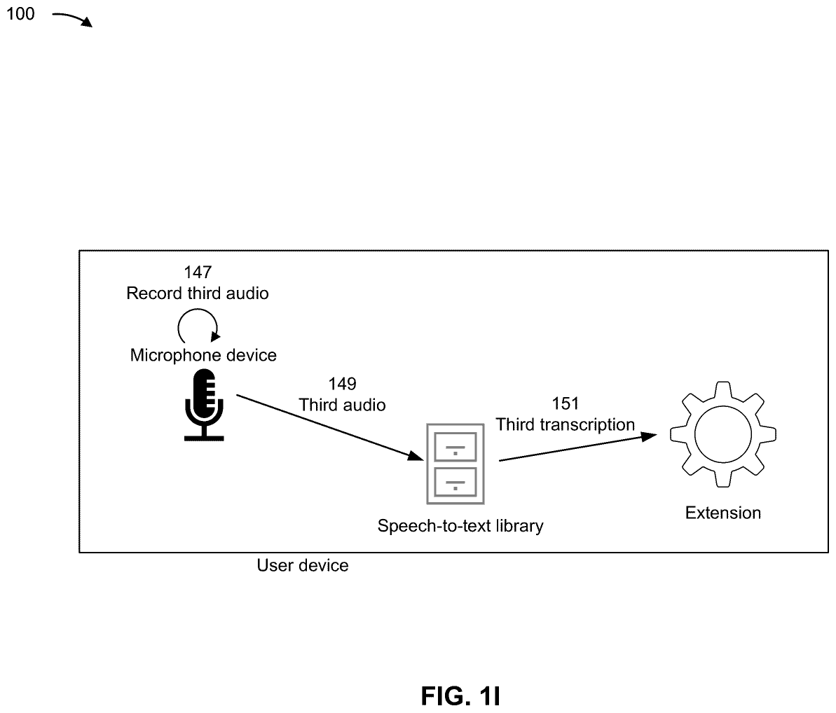

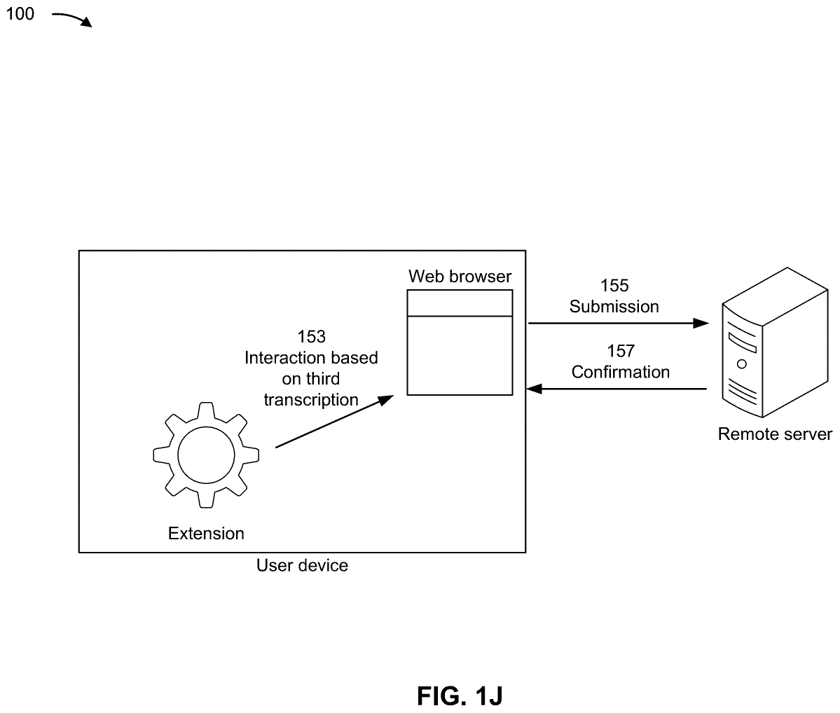

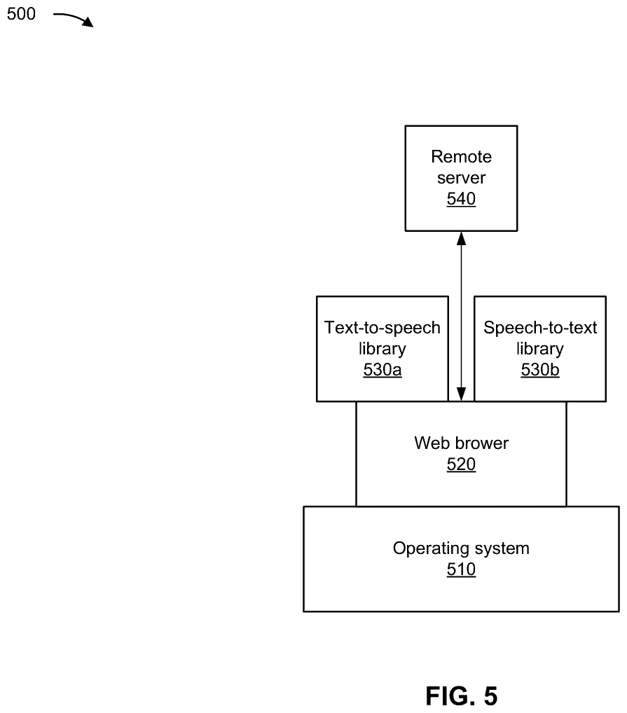

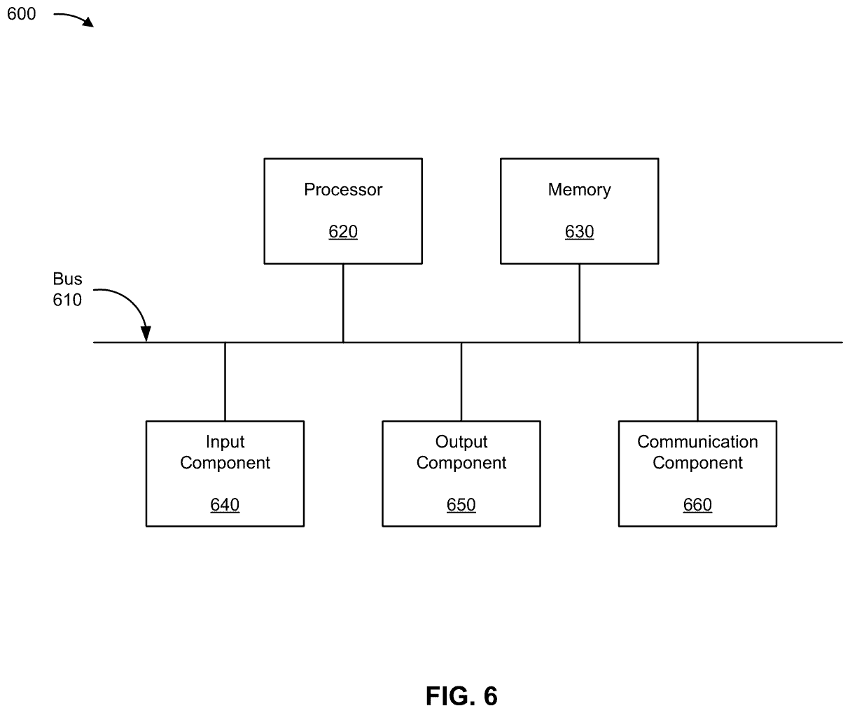

FIGS. 1A-1J are diagrams of an example 100 associated with completing web forms using audio. As shown in FIGS. 1A-1J, example 100 includes a user device and a remote server. These devices are described in more detail in connection with FIGS. 5 and 6. The user device may execute a web browser (e.g., over an OS executed on the user device). The user device may additionally include (or otherwise be associated with) an input device, a display device, a speaker device, and a microphone device. The web browser may additionally include an extension, which may be an application executed within the web browser rather than separately from the web browser.

As shown in FIG. 1A and by reference number 101, the web browser may receive (e.g., from the input device and/or via the OS) an indication of a web form. For example, the indication may include a web address associated with the web form. A user of the user device may use the input device (e.g., a keyboard, a mouse, and/or a touchscreen, among other examples) to enter the web address. For example, the user may enter the web address into an address bar of the web browser (whether via a keyboard or by speaking into the microphone device). In another example, the user may select a “favorite” or a “bookmark” that is associated with the web address (whether via a mouse or a touchscreen or by speaking into the microphone device). In some implementations, the user may further input a command (e.g., via the input device) to display the web form associated with the web address. For example, the user may hit “Enter,” select a button, or speak a command into the microphone device after entering the web address into the address bar. Alternatively, the user may enter the web address and input the command simultaneously (e.g., by clicking or tapping on a favorite or a bookmark).

As shown by reference number 103, the web browser may transmit, and the remote server may receive, a request for the web form in response to the indication of the web form. For example, the request may include a hypertext transfer protocol (HTTP) request, an application programming interface (API) call, and/or another similar type of request. In some implementations, the web browser may use a domain name service (DNS) to convert the web address to an Internet protocol (IP) address associated with the remote server and transmit the request based on the IP address. The web browser may transmit the request using a modem and/or another network device of the user device (e.g., via the OS of the user device). Accordingly, the web browser may transmit the request over the Internet and/or another type of network.

As shown by reference number 105, the remote server may transmit, and the web browser may receive, code comprising the web form (e.g., HTML code, CSS code, and/or JavaScript® code, among other examples). For example, the remote server may transmit files (e.g., one or more files) comprising the web form. At least one file may be an HTML file (and/or a CSS file) and remaining files may encode media associated with the web form (e.g., image files and/or another type of media files).

As shown by reference number 107, the web browser may show (e.g., using the display device) the web form. For example, the web browser may generate instructions for a user interface (UI) based on the code comprising the web form and transmit the instructions to the display device.

The web browser may receive input to trigger audio navigation of the web form loaded by the web browser. For example, the user of the user device may use a mouse click, a keyboard entry, or a touchscreen interaction to trigger audio navigation of the web form. Accordingly, the web browser may receive the input via the input device. Alternatively, the user of the user device may speak a command to trigger audio navigation of the web form. Accordingly, the web browser may receive the audio command via the microphone device. The web browser may activate the extension in response to the input. Alternatively, the extension may execute in the background and may receive the input directly.

As shown in FIG. 1B and by reference number 109, the extension of the web browser may identify a first label associated with a first input element of the web form. The extension may identify the first label in response to the input to trigger audio navigation of the web form. In some implementations, the first label may be indicated in HTML code (and/or CSS code) based at least in part on a tag (e.g., a <label> tag). Additionally, or alternatively, the first label may be identified as preceding the first input element indicated in the HTML code (and/or the CSS code) based at least in part on a tag (e.g., an <input> tag). By using HTML and/or CSS tags rather than machine learning to identify labels, the extension conserves power, processing resources, and memory.

As shown by reference number 111, the extension may apply a text-to-speech library (e.g., at least partially integrated with the web browser and/or the OS of the user device) to the first label. The text-to-speech library may include a dynamic-link library (DLL), a Java® library, or another type of shared library (or shared object). Accordingly, the text-to-speech library may comprise executable code that converts text into audio signals (e.g., for processing and conversion to sound waves by the speaker device). By using the text-to-speech library, the extension conserves power, processing resources, and memory as compared with implementing an independent text-to-speech algorithm similar to an external screen reader.

As shown by reference number 113, the extension may generate a first audio signal based on the first label using the text-to-speech library. Additionally, the extension may output the first audio signal to the speaker device for playback to the user of the user device. In some implementations, the extension may be authorized to access a driver of the speaker device directly and may therefore output the first audio signal directly to the driver of the speaker device. Alternatively, the extension may output the first audio signal to the OS of the user device for transmission to the driver of the speaker device.

In one example, the first input element is a text box, and the first audio signal is based on the first label associated with the text box. In another example, the first input element is a drop-down menu or a list of radio buttons, and the first audio signal is based on the first label as well as a plurality of options associated with the first input element. For example, the extension may identify the plurality of options as indicated in HTML code (and/or CSS code) based at least in part on a tag (e.g., an <input> tag associated with a “radio” type). Additionally, or alternatively, the plurality of options may be identified as preceding and/or succeeding the first input element indicated in the HTML code (and/or the CSS code).

As shown in FIG. 1C and by reference number 115, the microphone device may generate first recorded audio after the first audio signal is played. In some implementations, the extension may be authorized to access a driver of the microphone device directly and may therefore initiate recording of the first audio directly via the driver of the microphone device. Alternatively, the extension may transmit a request to the OS of the user device to initiate recording of the first audio via the driver of the microphone device.

The microphone device may begin recording the first audio based on a trigger. For example, the trigger may include a command from the extension (e.g., directly or via the OS, as described above). The extension may transmit the trigger based on an amount of time (e.g., satisfying a beginning threshold) after outputting the first audio signal to the speaker device. Alternatively, the extension may receive a signal from the speaker device (e.g., directly or via the OS) after the first audio signal has finished playing. Accordingly, the extension may transmit the trigger based on an amount of time (e.g., satisfying the beginning threshold) after receiving the signal from the speaker device. Additionally, or alternatively, the trigger may include detection that the user of the user device has begun speaking. For example, the microphone may record audio in the background and detect that the user has begun speaking based on a change in volume, frequency, and/or another characteristic of the audio being recorded (e.g., satisfying a change threshold). In a combinatory example, the extension may transmit a command that triggers the microphone device to monitor for the user of the user device to begin speaking.

In some implementations, the microphone device may terminate recording the first audio based on an additional trigger. For example, the additional trigger may include an additional command from the extension (e.g., directly or via the OS, as described above). The extension may transmit the additional trigger based on an amount of time (e.g., satisfying a terminating threshold) after transmitting the trigger to initiate recording to the speaker device. Additionally, or alternatively, the trigger may include detection that the user of the user device has stopped speaking. For example, the microphone may detect that the user has stopped speaking based on a change in volume, frequency, and/or another characteristic of the first audio being recorded (e.g., satisfying a change threshold). In a combinatory example, the extension may transmit an additional command that triggers the microphone device to monitor for the user of the user device to stop speaking.

Alternatively, the microphone device may terminate recording the first audio based on a timer. For example, the microphone device may start the timer when the microphone device begins recording the first audio. The timer may be set to a default value or to a value indicated by the extension. For example, the user of the user device may transmit an indication of a setting (e.g., a raw value or a selection from a plurality of possible values), and the extension may indicate the value for the timer to the microphone device based on the setting.

As shown by reference number 117, the extension may apply a speech-to-text library (e.g., at least partially integrated with the web browser and/or the OS of the user device) to the first audio. The speech-to-text library may include a DLL, a Java library, or another type of shared library (or shared object). Accordingly, the speech-to-text library may comprise executable code that converts audio signals into text. By using the speech-to-text library, the extension conserves power, processing resources, and memory as compared with implementing an independent speech-to-text algorithm similar to an external screen reader.

As shown by reference number 119, the extension may generate a first transcription based on the first audio using the speech-to-text library. In one example, the first audio may comprise speech with letters. For example, the user may have spelled her/his input. Accordingly, the first transcription may include a transcription of the letters (and optionally any symbols, such as spaces or commas, among other examples). In another example, the first audio may comprise speech with words. Accordingly, the first transcription may include translation of the first audio to corresponding words of text (e.g., based on phonemes).

As shown in FIG. 1D and by reference number 121, the extension may provide input for the first input element of the web form based on the first transcription. Accordingly, the extension may modify the first input element based on the first transcription. For example, the first input element may be a text box, and the extension may insert the first transcription into the first input element. In another example, the first input element may be a drop-down menu or a list of radio buttons, and the extension may select one option, of a plurality of options associated with the first input element, based on the first transcription. For example, the extension may determine that the first transcription matches the option associated with the first input element. As used herein, “match” may refer to a similarity score between objects satisfying a similarity threshold. The similarity score may be based on matching letters, matching characters, bitwise matching, or another type of correspondence between portions of the objects being compared.

In some implementations, as shown by reference number 123, the web browser may transmit, and the remote server may receive, an indication of the input for the first input element of the web form. Accordingly, as shown by reference number 125, the remote server may transmit, and the web browser may receive, a confirmation of the input.

The extension may further identify a second label associated with a second input element of the web form. The extension may identify the second label after modifying the first input element. Alternatively, the extension may identify the second label in response to the input to trigger audio navigation of the web form. For example, the extension may identify all labels associated with input elements of the web form before beginning audio navigation of the web form.

As described above, the second label may be indicated in HTML code (and/or CSS code) based at least in part on a tag (e.g., a <label> tag). Additionally, or alternatively, the second label may be identified as preceding the second input element indicated in the HTML code (and/or the CSS code) based at least in part on a tag (e.g., an <input> tag).

As shown in FIG. 1E and by reference number 127, the extension may apply the text-to-speech library to the second label. As shown by reference number 129, the extension may generate a second audio signal based on the second label using the text-to-speech library. Additionally, the extension may output the second audio signal to the speaker device (e.g., directly or via the OS, as described above) for playback to the user of the user device.

In one example, the second input element is a text box, and the second audio signal is based on the second label associated with the text box. In another example, the second input element is a drop-down menu or a list of radio buttons, and the second audio signal is based on the second label as well as a plurality of options associated with the second input element. For example, the extension may identify the plurality of options as indicated in HTML code (and/or CSS code) based at least in part on a tag (e.g., an <input> tag associated with a “radio” type). Additionally, or alternatively, the plurality of options may be identified as preceding and/or succeeding the second input element indicated in the HTML code (and/or the CSS code).

As shown in FIG. 1F and by reference number 131, the microphone device may generate second recorded audio after the second audio signal is played. The microphone device may begin recording the second audio based on a trigger, as described above. In some implementations, the microphone device may terminate recording the second audio based on an additional trigger, as described above. Alternatively, the microphone device may terminate recording the second audio based on a timer, as described above.

As shown by reference number 133, the extension may apply the speech-to-text library to the second audio. As shown by reference number 135, the extension may generate a second transcription based on the second audio using the speech-to-text library. In one example, the second audio may comprise speech with letters. For example, the user may have spelled her/his input. Accordingly, the second transcription may include a transcription of the letters (and optionally any symbols, such as spaces or commas, among other examples). In another example, the second audio may comprise speech with words. Accordingly, the second transcription may include translation of the second audio to corresponding words of text (e.g., based on phonemes).

As shown in FIG. 1G and by reference number 137, the extension may provide input for the second input element of the web form based on the second transcription. Accordingly, the extension may modify the second input element based on the second transcription. For example, the second input element may be a text box, and the extension may insert the second transcription into the second input element. In another example, the second input element may be a drop-down menu or a list of radio buttons, and the extension may select one option, of a plurality of options associated with the second input element, based on the second transcription. For example, the extension may determine that the second transcription matches the option associated with the second input element.

In some implementations, as shown by reference number 139, the web browser may transmit, and the remote server may receive, an indication of the input for the second input element of the web form. Accordingly, as shown by reference number 141, the remote server may transmit, and the web browser may receive, a confirmation of the input.

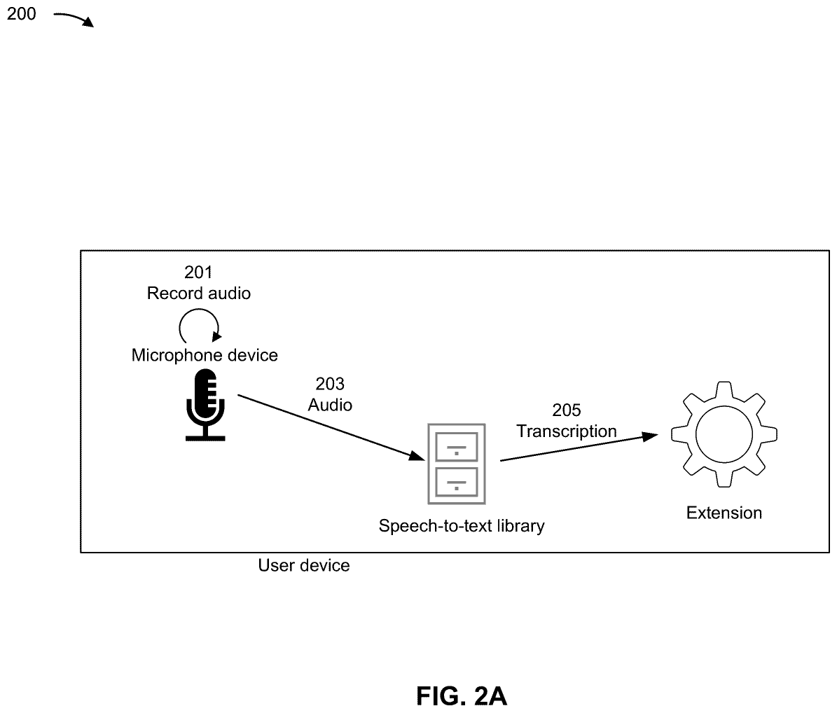

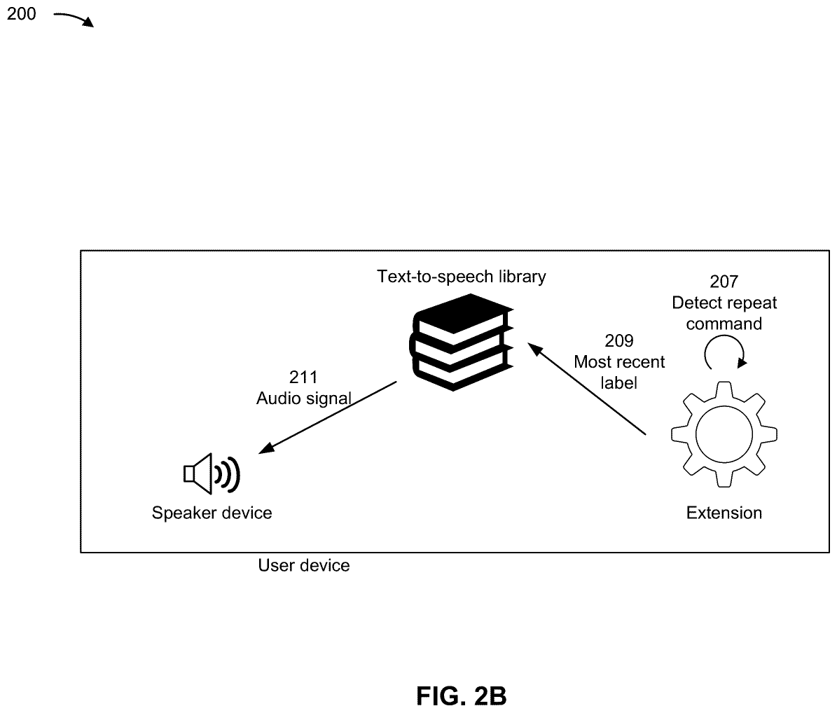

The extension may iterate through additional labels and input elements of the web form until an end of the web form. For example, the extension may identify the end of the web form in HTML code (and/or CSS code) based at least in part on a tag (e.g., a </form> tag). Additionally, or alternatively, the end of the web form may be identified as near a submission button indicated in the HTML code (and/or the CSS code) based at least in part on a tag (e.g., an <input> tag with a “submit” type). In some implementations, the extension may additionally process commands identified in transcriptions during audio navigation of the web form (e.g., as described in connection with FIGS. 2A-2B, FIGS. 3A-3D, and FIGS. 4A-4B).

At the end of the web form, the extension may identify the submission button. For example, the submission button may be identified in the HTML code (and/or the CSS code) based at least in part on a tag (e.g., an <input > tag with a “submit” type). Additionally, or alternatively, the submission button may be identified as preceding the end of the web form in the HTML code (and/or the CSS code) based at least in part on a tag (e.g., a </form> tag).

As shown in FIG. 1H and by reference number 143, the extension may apply the text-to-speech library to a label associated with the submission button. For example, the extension may apply the text-to-speech library to the text associated with the “value” attribute of the button. As shown by reference number 145, the extension may generate a submission audio signal based on the label associated with the submission button using the text-to-speech library. Additionally, the extension may output the submission audio signal to the speaker device (e.g., directly or via the OS, as described above) for playback to the user of the user device.

As shown in FIG. 1I and by reference number 147, the microphone device may record submission audio after the submission audio signal is played. The microphone device may begin recording the submission audio based on a trigger, as described above. In some implementations, the microphone device may terminate recording the submission audio based on an additional trigger, as described above. Alternatively, the microphone device may terminate recording the submission audio based on a timer, as described above.

As shown by reference number 149, the extension may apply the speech-to-text library to the submission audio. As shown by reference number 151, the extension may generate a submission transcription based on the submission audio using the speech-to-text library. The submission transcription may include translation of the submission audio to corresponding words, such as “Yes” or “No,” “Accept” or “Decline,” “Submit” or “Don't submit,” among other examples.

As shown in FIG. 1J and by reference number 153, the extension may activate the submission button of the web form based on the submission transcription. For example, the extension may determine that the submission transcription matches a command, out of a plurality of possible commands, associated with activating the submission button.

In some implementations, as shown by reference number 155, the web browser may transmit, and the remote server may receive, an indication of the submission of the web form. Additionally, the web browser may transmit, and the remote server may receive, information from the modified input elements of the web form. Accordingly, the remote server may receive input from the user of the user device based on the audio interactions described herein. As shown by reference number 157, the remote server may transmit, and the web browser may receive, a confirmation of the submission. For example, the remote server may transmit code for a confirmation webpage associated with the web form. Accordingly, the web browser may display the confirmation webpage, similarly as described above for the web form.

In some implementations, the user device may receive feedback associated with the audio signals and/or the transcriptions. For example, the user may indicate (e.g., using the input device and/or the microphone device) a rating associated with an audio signal or a transcription. Additionally, or alternatively, the user may indicate a preferred audio signal for a label and/or a preferred transcription for audio.

Accordingly, the user device may update the text-to-speech library and/or the speech-to-text library based on the feedback. For example, the user device may tune trained parameters of the text-to-speech library and/or the speech-to-text library based on a rating, a preferred audio signal, and/or a preferred transcription indicated by the user. Additionally, or alternatively, the user device may apply a filter over the text-to-speech library and/or the speech-to-text library in order to ensure a preferred audio signal and/or a preferred transcription indicated by the user.

By using techniques as described in connection with FIGS. 1A-1J, the text-to-speech library and the speech-to-text library facilitate interaction for visually impaired users. Using the libraries of the web browser and/or the OS conserves power, processing resources, and memory that external screen readers would otherwise consume. Additionally, using HTML and/or CSS to readily identify the labels to convert to the audio signals conserves power, processing resources, and memory that external screen readers would otherwise consume in reading superfluous information.

As indicated above, FIGS. 1A-1J are provided as an example. Other examples may differ from what is described with regard to FIGS. 1A-1J.

FIGS. 2A-2B are diagrams of an example 200 associated with navigating web forms using audio. As shown in FIGS. 2A-2B, example 200 includes a user device, which is described in more detail in connection with FIGS. 5 and 6. The user device may execute a web browser (e.g., over an OS executed on the user device). The user device may additionally include (or otherwise be associated with) an input device, a display device, a speaker device, and a microphone device. The web browser may additionally include an extension, which may be an application executed within the web browser rather than separately from the web browser.

As shown in FIG. 2A and by reference number 201, the microphone device may record audio. In some implementations, the microphone device may record audio after an audio signal is played (e.g., as described in connection with FIG. 1B). In some implementations, the extension may be authorized to access a driver of the microphone device directly and may therefore initiate recording of the audio directly via the driver of the microphone device. Alternatively, the extension may transmit a request to the OS of the user device to initiate recording of the audio via the driver of the microphone device.

As described in connection with reference number 115 of FIG. 1C, the microphone device may begin recording the audio based on a trigger. In some implementations, the microphone device may terminate recording the audio based on an additional trigger. Alternatively, the microphone device may terminate recording the audio based on a timer.

As shown by reference number 203, the extension may apply a speech-to-text library (e.g., at least partially integrated with the web browser and/or the OS of the user device) to the audio. The speech-to-text library may include a DLL, a Java library, or another type of shared library (or shared object). Accordingly, the speech-to-text library may comprise executable code that converts audio signals into text. By using the speech-to-text library, the extension conserves power, processing resources, and memory as compared with implementing an independent speech-to-text algorithm similar to an external screen reader.

As shown by reference number 205, the extension may generate a transcription based on the audio using the speech-to-text library. The audio may comprise speech with words. Accordingly, the transcription may include translation of the audio to corresponding words (e.g., based on phonemes).

As shown in FIG. 2B and by reference number 207, the extension may determine that the transcription is associated with a repeat command. For example, the transcription may include a word or a phrase associated with the repeat command, such as “Repeat,” “What?” “Come again?” “Please repeat,” “What was that?” or “Say again,” among other examples. In some implementations, the extension may detect the repeat command only when the transcription does not include words or phrases not associated with the repeat command. Alternatively, the extension may detect the repeat command based on the transcription failing to satisfy a false positive threshold (e.g., a percentage of characters or a percentage of words, among other examples) even when the transcription includes words or phrases unassociated with the repeat command.

Accordingly, as shown by reference number 209, the extension may re-apply a text-to-speech library (e.g., at least partially integrated with the web browser and/or the OS of the user device) to a most recent label. The text-to-speech library may include a DLL, a Java library, or another type of shared library (or shared object). Accordingly, the text-to-speech library may comprise executable code that converts text into audio signals (e.g., for processing and conversion to sound waves by the speaker device). By using the text-to-speech library, the extension conserves power, processing resources, and memory as compared with implementing an independent text-to-speech algorithm similar to an external screen reader.

As shown by reference number 211, the extension may generate an audio signal based on the most recent label using the text-to-speech library. Additionally, the extension may output the audio signal to the speaker device for playback to the user of the user device. Accordingly, the audio signal may be repeated based on the repeat command. In some implementations, the extension may be authorized to access a driver of the speaker device directly and may therefore output the audio signal directly to the driver of the speaker device. Alternatively, the extension may output the audio signal to the OS of the user device for transmission to the driver of the speaker device.

By using techniques as described in connection with FIGS. 2A-2B, the speech-to-text library may be used to detect the repeat command from the user, which conserves power, processing resources, and memory as compared with programming, debugging, deploying, and executing a custom speech-to-text library that is trained to detect the repeat command.

As indicated above, FIGS. 2A-2B are provided as an example. Other examples may differ from what is described with regard to FIGS. 2A-2B.

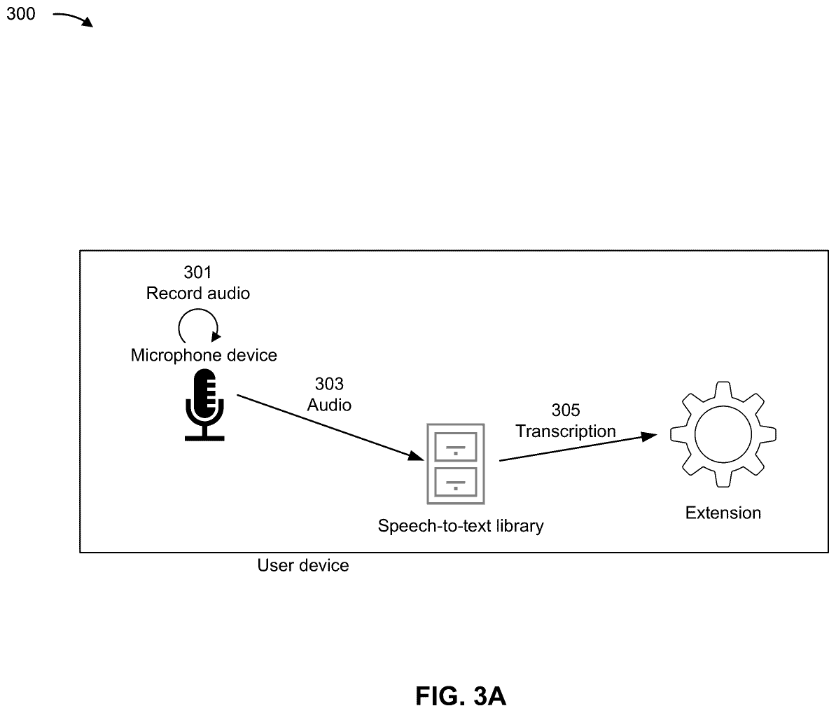

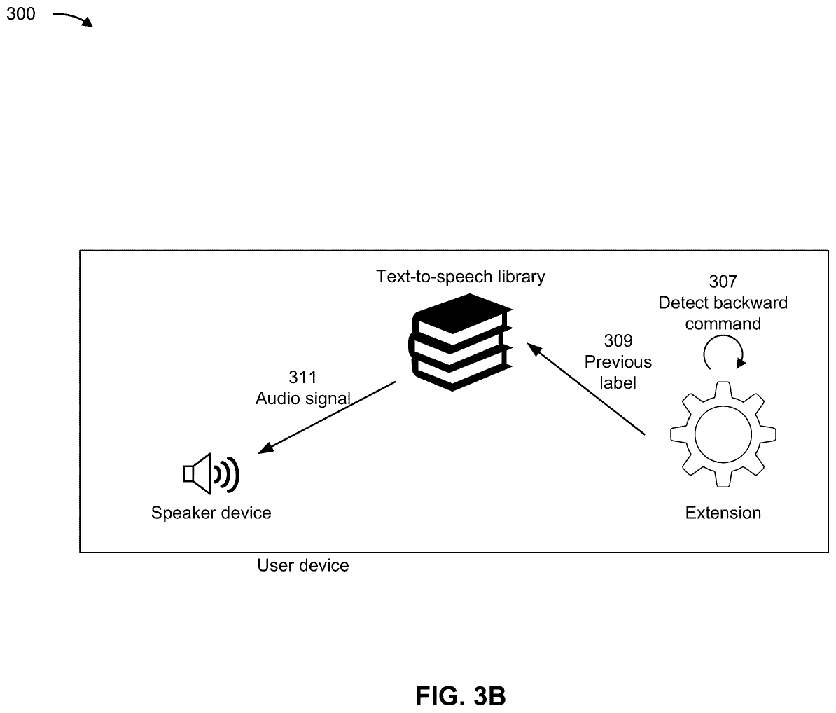

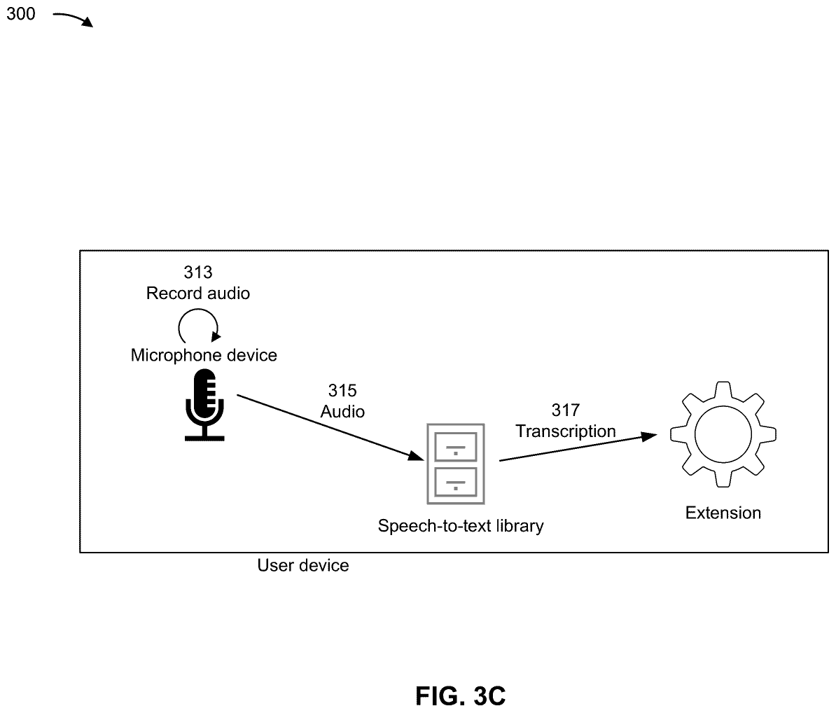

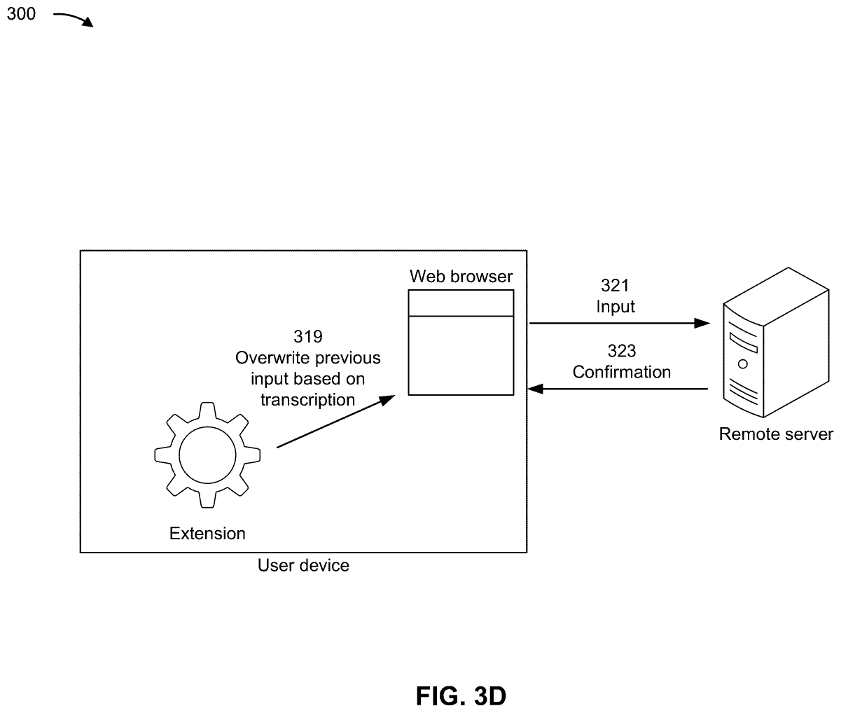

FIGS. 3A-3D are diagrams of an example 300 associated with navigating web forms using audio. As shown in FIGS. 3A-3D, example 300 includes a user device and a remote server, which are described in more detail in connection with FIGS. 5 and 6. The user device may execute a web browser (e.g., over an OS executed on the user device). The user device may additionally include (or otherwise be associated with) an input device, a display device, a speaker device, and a microphone device. The web browser may additionally include an extension, which may be an application executed within the web browser rather than separately from the web browser.

As shown in FIG. 3A and by reference number 301, the microphone device may record audio. In some implementations, the microphone device may record audio after an audio signal is played (e.g., as described in connection with FIG. 1B). In some implementations, the extension may be authorized to access a driver of the microphone device directly and may therefore initiate recording of the audio directly via the driver of the microphone device. Alternatively, the extension may transmit a request to the OS of the user device to initiate recording of the audio via the driver of the microphone device.

As described in connection with reference number 115 of FIG. 1C, the microphone device may begin recording the audio based on a trigger. In some implementations, the microphone device may terminate recording the audio based on an additional trigger. Alternatively, the microphone device may terminate recording the audio based on a timer.

As shown by reference number 303, the extension may apply a speech-to-text library (e.g., at least partially integrated with the web browser and/or the OS of the user device) to the audio. The speech-to-text library may include a DLL, a Java library, or another type of shared library (or shared object). Accordingly, the speech-to-text library may comprise executable code that converts audio signals into text. By using the speech-to-text library, the extension conserves power, processing resources, and memory as compared with implementing an independent speech-to-text algorithm similar to an external screen reader.

As shown by reference number 305, the extension may generate a transcription based on the audio using the speech-to-text library. The audio may comprise speech with words. Accordingly, the transcription may include translation of the audio to corresponding words (e.g., based on phonemes).

As shown in FIG. 3B and by reference number 307, the extension may determine that the transcription is associated with a backward command. For example, the transcription may include a word or a phrase associated with the backward command, such as “Go back,” “Repeat previous field,” “Back,” or “Previous,” among other examples. In some implementations, the extension may detect the backward command only when the transcription does not include words or phrases not associated with the backward command. Alternatively, the extension may detect the backward command based on the transcription failing to satisfy a false positive threshold (e.g., a percentage of characters or a percentage of words, among other examples) even when the transcription includes words or phrases unassociated with the backward command.

Accordingly, as shown by reference number 309, the extension may apply a text-to-speech library (e.g., at least partially integrated with the web browser and/or the OS of the user device) to a previous label. The text-to-speech library may include a DLL, a Java library, or another type of shared library (or shared object). Accordingly, the text-to-speech library may comprise executable code that converts text into audio signals (e.g., for processing and conversion to sound waves by the speaker device). By using the text-to-speech library, the extension conserves power, processing resources, and memory as compared with implementing an independent text-to-speech algorithm similar to an external screen reader.

As shown by reference number 311, the extension may generate an audio signal based on the previous label using the text-to-speech library. Additionally, the extension may output the audio signal to the speaker device for playback to the user of the user device. Accordingly, a previous audio signal may be repeated based on the backward command. In some implementations, the extension may be authorized to access a driver of the speaker device directly and may therefore output the audio signal directly to the driver of the speaker device. Alternatively, the extension may output the audio signal to the OS of the user device for transmission to the driver of the speaker device.

As shown in FIG. 3C and by reference number 313, the microphone device may record new audio after the audio signal is played. As described in connection with reference number 115 of FIG. 1C, the microphone device may begin recording the new audio based on a trigger. In some implementations, the microphone device may terminate recording the new audio based on an additional trigger. Alternatively, the microphone device may terminate recording the new audio based on a timer.

As shown by reference number 315, the extension may apply the speech-to-text library to the new audio. As shown by reference number 317, the extension may generate a transcription based on the new audio using the speech-to-text library. In one example, the new audio may comprise speech with letters. For example, the user may have spelled her/his input. Accordingly, the transcription may include a transcription of the letters (and optionally any symbols, such as spaces or commas, among other examples). In another example, the new audio may comprise speech with words. Accordingly, the first transcription may include translation of the new audio to corresponding words (e.g., based on phonemes).

As shown in FIG. 3D and by reference number 319, the extension may overwrite previous input for an input element (e.g., corresponding to the previous label) of the web form based on the transcription. Accordingly, the extension may re-modify the input element based on the transcription. For example, the input element may be a text box, and the extension may insert the transcription into the input element (thus overwriting a previous transcription of previous audio). In another example, the input element may be a drop-down menu or a list of radio buttons, and the extension may select a new option, of a plurality of options associated with the input element, based on the transcription (thus overwriting a previously selected option based on a previous transcription of previous audio). For example, the extension may determine that the transcription matches the new option associated with the input element.

In some implementations, as shown by reference number 321, the web browser may transmit, and the remote server may receive, an indication of new input for the input element of the web form. Accordingly, as shown by reference number 323, the remote server may transmit, and the web browser may receive, a confirmation of the new input.

By using techniques as described in connection with FIGS. 3A-3D, the speech-to-text library may be used to detect the backward command from the user, which conserves power, processing resources, and memory as compared with programming, debugging, deploying, and executing a custom speech-to-text library that is trained to detect the backward command.

As indicated above, FIGS. 3A-3D are provided as an example. Other examples may differ from what is described with regard to FIGS. 3A-3D.

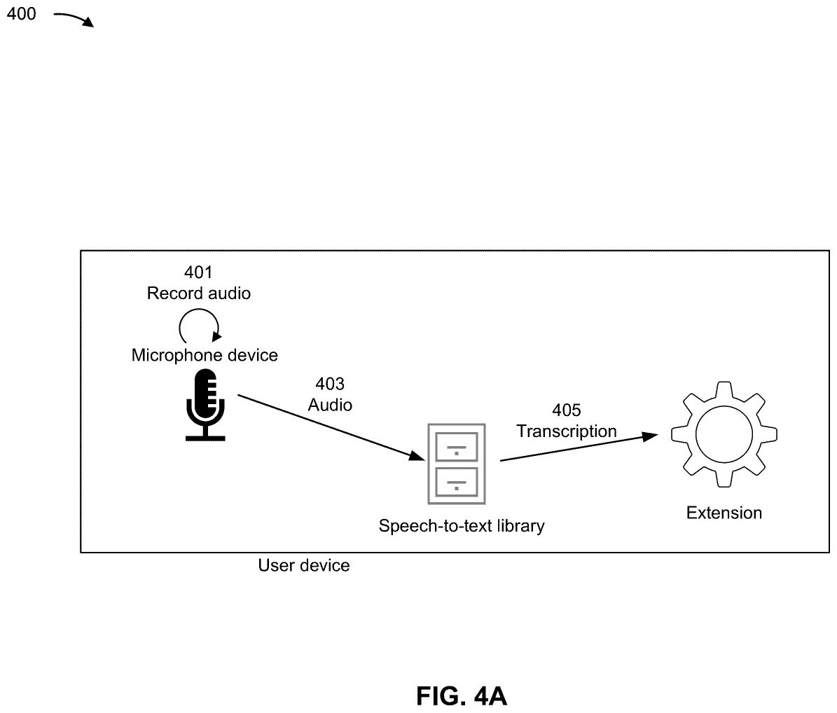

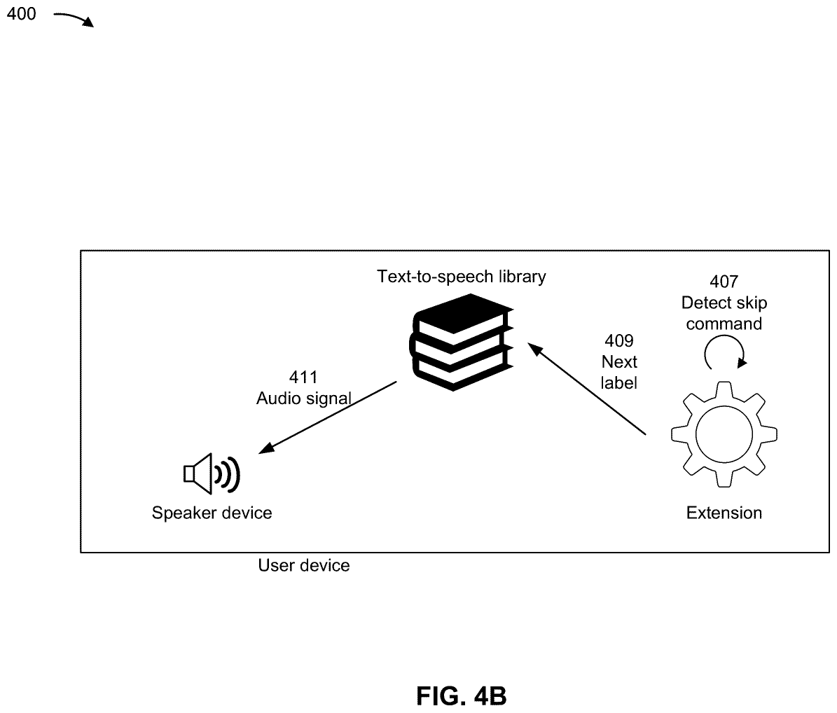

FIGS. 4A-4B are diagrams of an example 400 associated with navigating web forms using audio. As shown in FIGS. 4A-4B, example 400 includes a user device, which is described in more detail in connection with FIGS. 5 and 6. The user device may execute a web browser (e.g., over an OS executed on the user device). The user device may additionally include (or otherwise be associated with) an input device, a display device, a speaker device, and a microphone device. The web browser may additionally include an extension, which may be an application executed within the web browser rather than separately from the web browser.

As shown in FIG. 4A and by reference number 401, the microphone device may record audio. In some implementations, the microphone device may record audio after an audio signal is played (e.g., as described in connection with FIG. 1B). In some implementations, the extension may be authorized to access a driver of the microphone device directly and may therefore initiate recording of the audio directly via the driver of the microphone device. Alternatively, the extension may transmit a request to the OS of the user device to initiate recording of the audio via the driver of the microphone device.

As described in connection with reference number 115 of FIG. 1C, the microphone device may begin recording the audio based on a trigger. In some implementations, the microphone device may terminate recording the audio based on an additional trigger. Alternatively, the microphone device may terminate recording the audio based on a timer.

As shown by reference number 403, the extension may apply a speech-to-text library (e.g., at least partially integrated with the web browser and/or the OS of the user device) to the audio. The speech-to-text library may include a DLL, a Java library, or another type of shared library (or shared object). Accordingly, the speech-to-text library may comprise executable code that converts audio signals into text. By using the speech-to-text library, the extension conserves power, processing resources, and memory as compared with implementing an independent speech-to-text algorithm similar to an external screen reader.

As shown by reference number 405, the extension may generate a transcription based on the audio using the speech-to-text library. The audio may comprise speech with words. Accordingly, the transcription may include translation of the audio to corresponding words (e.g., based on phonemes).

As shown in FIG. 4B and by reference number 407, the extension may determine that the transcription is associated with a skip command. For example, the transcription may include a word or a phrase associated with the skip command, such as “Next,” “Next please,” “Skip,” “Can we skip?” “Decline to answer,” or “Skip please,” among other examples. In some implementations, the extension may detect the skip command only when the transcription does not include words or phrases not associated with the skip command. Alternatively, the extension may detect the skip command based on the transcription failing to satisfy a false positive threshold (e.g., a percentage of characters or a percentage of words, among other examples) even when the transcription includes words or phrases unassociated with the skip command.

Accordingly, as shown by reference number 409, the extension may apply a text-to-speech library (e.g., at least partially integrated with the web browser and/or the OS of the user device) to a next label. The text-to-speech library may include a DLL, a Java library, or another type of shared library (or shared object). Accordingly, the text-to-speech library may comprise executable code that converts text into audio signals (e.g., for processing and conversion to sound waves by the speaker device). By using the text-to-speech library, the extension conserves power, processing resources, and memory as compared with implementing an independent text-to-speech algorithm similar to an external screen reader.

As shown by reference number 411, the extension may generate an audio signal based on the next label using the text-to-speech library. Additionally, the extension may output the audio signal to the speaker device for playback to the user of the user device. Accordingly, an input element associated with a previous label remains unmodified based on the skip command. In some implementations, the extension may be authorized to access a driver of the speaker device directly and may therefore output the audio signal directly to the driver of the speaker device. Alternatively, the extension may output the audio signal to the OS of the user device for transmission to the driver of the speaker device.

By using techniques as described in connection with FIGS. 4A-4B, the speech-to-text library may be used to detect the skip command from the user, which conserves power, processing resources, and memory as compared with programming, debugging, deploying, and executing a custom speech-to-text library that is trained to detect the skip command.

As indicated above, FIGS. 4A-4B are provided as an example. Other examples may differ from what is described with regard to FIGS. 4A-4B.

FIG. 5 is a diagram of an example environment 500 in which systems and/or methods described herein may be implemented. As shown in FIG. 5, environment 500 may include an operating system 510, a web browser 520 (e.g., supported by the operating system 510), and a text-to-speech library 530a with a speech-to-text library 530b (e.g., provided by the operating system 510 and used by the web browser 520 or provided by the web browser 520 for its own use), as described in more detail below. The operating system 510, the web browser 520, and the libraries 530a and 530b may be executed on a user device. The user device may include a communication device. For example, the user device may include a wireless communication device, a user equipment (UE), a mobile phone (e.g., a smart phone or a cell phone, among other examples), a laptop computer, a tablet computer, a handheld computer, a desktop computer, a gaming device, a wearable communication device (e.g., a smart wristwatch or a pair of smart eyeglasses, among other examples), an Internet of Things (IOT) device, or a similar type of device. The user device may include a speaker device to transmit audio to a user. The user device may further include an input device and a microphone device to facilitate interaction with a user. Example input devices include a keyboard, a touchscreen, and/or a mouse. Additionally, as further shown in FIG. 5, environment 500 may include a remote server 540. Devices and/or elements of environment 500 may interconnect via wired connections and/or wireless connections.

The operating system 510 may include system software capable of managing hardware of the user device (which may include, for example, one or more components of device 600 of FIG. 6) and providing an environment for execution of higher-level software, such as the web browser 520. For example, the operating system 510 may include a kernel (e.g., a Windows-based kernel, a Linux kernel, a Unix-based kernel, such as an Android kernel, an iOS kernel, and/or another type of kernel) managing the hardware and library functions that may be used by the higher-level software. The operating system 510 may additionally provide a UI and process input from a user. In some implementations, the operating system 510 may additionally provide the text-to-speech library 530a and the speech-to-text library 530b.

The web browser 520 may include an executable capable of running on a user device using the operating system 510. In some implementations, the web browser 520 may communicate with the remote server 540. For example, the web browser 520 may use an HTTP, a file transfer protocol (FTP), and/or another Internet- or network-based protocol to request information from, transmit information to, and receive information from the remote server 540. Additionally, the web browser 520 may provide, or at least access, the text-to-speech library 530a and the speech-to-text library 530b, as described elsewhere herein. The web browser 520 may support an extension, a plug-in, or another type of software that executes on top of the web browser 520.

The text-to-speech library 530a may include a built-in executable portion of the web browser 520 or a shared library (or shared object) used by the web browser 520. The text-to-speech library 530a may accept text as input and output audio signals for a speaker device. Similarly, the speech-to-text library 530b may include a built-in executable portion of the web browser 520 or a shared library (or shared object) used by the web browser 520. The speech-to-text library 530b may accept digitally encoded audio as input and output text based thereon.

The remote server 540 may include remote computing devices that provide information to requesting devices over the Internet and/or another network (e.g., a cellular network, a public land mobile network (PLMN), a local area network (LAN), a wide area network (WAN), a private network, the Internet, and/or a combination of these or other types of networks). The remote server 540 may include a standalone server, one or more servers included on a server farm, or one or more servers spread across a plurality of server farms. In some implementations, the remote server 540 may include a cloud computing system. As an alternative, the remote server 540 may include one or more devices, such as device 600 of FIG. 6, that may include a standalone server or another type of computing device.

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of environment 500 may perform one or more functions described as being performed by another set of devices of environment 500.

FIG. 6 is a diagram of example components of a device 600 associated with navigating and completing web forms using audio. The device 600 may correspond to a user device described herein. In some implementations, the user device may include one or more devices 600 and/or one or more components of the device 600. As shown in FIG. 6, the device 600 may include a bus 610, a processor 620, a memory 630, an input component 640, an output component 650, and/or a communication component 660.

The bus 610 may include one or more components that enable wired and/or wireless communication among the components of the device 600. The bus 610 may couple together two or more components of FIG. 6, such as via operative coupling, communicative coupling, electronic coupling, and/or electric coupling. For example, the bus 610 may include an electrical connection (e.g., a wire, a trace, and/or a lead) and/or a wireless bus. The processor 620 may include a central processing unit, a graphics processing unit, a microprocessor, a controller, a microcontroller, a digital signal processor, a field-programmable gate array, an application-specific integrated circuit, and/or another type of processing component. The processor 620 may be implemented in hardware, firmware, or a combination of hardware and software. In some implementations, the processor 620 may include one or more processors capable of being programmed to perform one or more operations or processes described elsewhere herein.

The memory 630 may include volatile and/or nonvolatile memory. For example, the memory 630 may include random access memory (RAM), read only memory (ROM), a hard disk drive, and/or another type of memory (e.g., a flash memory, a magnetic memory, and/or an optical memory). The memory 630 may include internal memory (e.g., RAM, ROM, or a hard disk drive) and/or removable memory (e.g., removable via a universal serial bus connection). The memory 630 may be a non-transitory computer-readable medium. The memory 630 may store information, one or more instructions, and/or software (e.g., one or more software applications) related to the operation of the device 600. In some implementations, the memory 630 may include one or more memories that are coupled (e.g., communicatively coupled) to one or more processors (e.g., processor 620), such as via the bus 610. Communicative coupling between a processor 620 and a memory 630 may enable the processor 620 to read and/or process information stored in the memory 630 and/or to store information in the memory 630.

The input component 640 may enable the device 600 to receive input, such as user input and/or sensed input. For example, the input component 640 may include a touch screen, a keyboard, a keypad, a mouse, a button, a microphone, a switch, a sensor, a global positioning system sensor, an accelerometer, a gyroscope, and/or an actuator. The output component 650 may enable the device 600 to provide output, such as via a display, a speaker, and/or a light-emitting diode. The communication component 660 may enable the device 600 to communicate with other devices via a wired connection and/or a wireless connection. For example, the communication component 660 may include a receiver, a transmitter, a transceiver, a modem, a network interface card, and/or an antenna.

The device 600 may perform one or more operations or processes described herein. For example, a non-transitory computer-readable medium (e.g., memory 630) may store a set of instructions (e.g., one or more instructions or code) for execution by the processor 620. The processor 620 may execute the set of instructions to perform one or more operations or processes described herein. In some implementations, execution of the set of instructions, by one or more processors 620, causes the one or more processors 620 and/or the device 600 to perform one or more operations or processes described herein. In some implementations, hardwired circuitry may be used instead of or in combination with the instructions to perform one or more operations or processes described herein. Additionally, or alternatively, the processor 620 may be configured to perform one or more operations or processes described herein. Thus, implementations described herein are not limited to any specific combination of hardware circuitry and software.

The number and arrangement of components shown in FIG. 6 are provided as an example. The device 600 may include additional components, fewer components, different components, or differently arranged components than those shown in FIG. 6. Additionally, or alternatively, a set of components (e.g., one or more components) of the device 600 may perform one or more functions described as being performed by another set of components of the device 600.

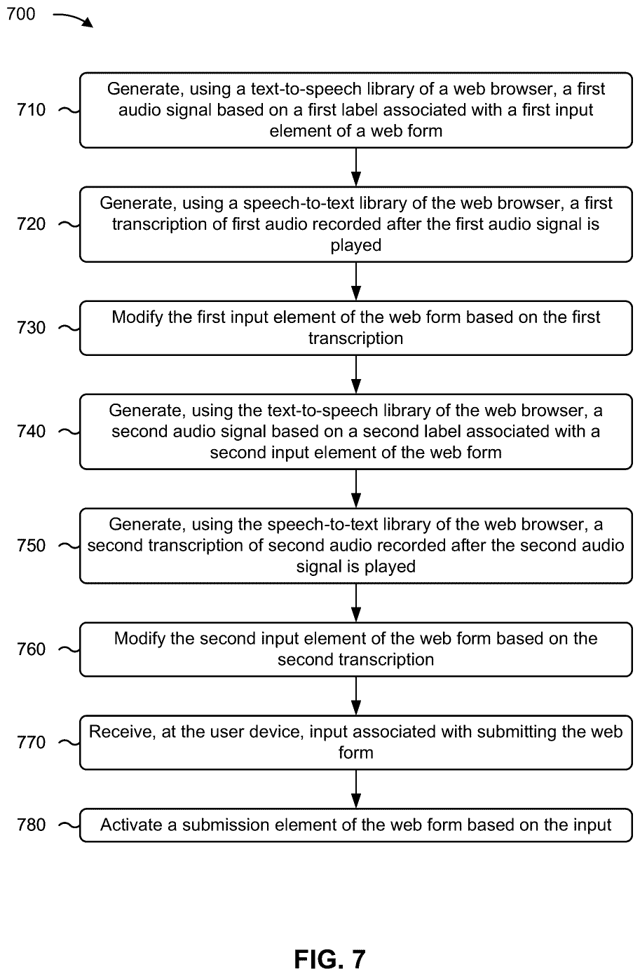

FIG. 7 is a flowchart of an example process 700 associated with navigating and completing web forms using audio. In some implementations, one or more process blocks of FIG. 7 may be performed by the user device. In some implementations, one or more process blocks of FIG. 7 may be performed by another device or a group of devices separate from or including the user device, such as the remote server 540. Additionally, or alternatively, one or more process blocks of FIG. 7 may be performed by one or more components of the device 600, such as processor 620, memory 630, input component 640, output component 650, and/or communication component 660.

As shown in FIG. 7, process 700 may include generating, using a text-to-speech library of a web browser, a first audio signal based on a first label associated with a first input element of a web form (block 710). For example, the user device (e.g., using processor 620 and/or memory 630) may generate, using a text-to-speech library of a web browser, a first audio signal based on a first label associated with a first input element of a web form, as described above in connection with reference numbers 111 and 113 of FIG. 1B. As an example, the user device may identify the first label using HTML code (and/or CSS code) based at least in part on a tag (e.g., a <label> tag). Additionally, or alternatively, the user device may identify the first label as preceding the first input element indicated in the HTML code (and/or the CSS code) based at least in part on a tag (e.g., an <input> tag). Accordingly, the user device may generate the first audio signal based on the first label using the text-to-speech library.

As further shown in FIG. 7, process 700 may include generating, using a speech-to-text library of the web browser, a first transcription of first audio recorded after the first audio signal is played (block 720). For example, the user device (e.g., using processor 620 and/or memory 630) may generate, using a speech-to-text library of the web browser, a first transcription of first audio recorded after the first audio signal is played, as described above in connection with reference numbers 117 and 119 of FIG. 1C. As an example, the first audio may comprise speech with letters. Accordingly, the first transcription may include a transcription of the letters (and optionally any symbols, such as spaces or commas, among other examples). In another example, the first audio may comprise speech with words. Accordingly, the first transcription may include translation of the first audio to corresponding words (e.g., based on phonemes).

As further shown in FIG. 7, process 700 may include modifying the first input element of the web form based on the first transcription (block 730). For example, the user device (e.g., using processor 620 and/or memory 630) may modify the first input element of the web form based on the first transcription, as described above in connection with reference number 121 of FIG. 1D. As an example, the first input element may be a text box, and the user device may insert the first transcription into the first input element. In another example, the first input element may be a drop-down menu or a list of radio buttons, and the user device may select one option, of a plurality of options associated with the first input element, based on the first transcription. For example, the user device may determine that the first transcription matches the option associated with the first input element.

As further shown in FIG. 7, process 700 may include generating, using the text-to-speech library of the web browser, a second audio signal based on a second label associated with a second input element of the web form (block 740). For example, the user device (e.g., using processor 620 and/or memory 630) may generate, using the text-to-speech library of the web browser, a second audio signal based on a second label associated with a second input element of the web form, as described above in connection with reference numbers 127 and 129 of FIG. 1E. As an example, the user device may identify the second label using HTML code (and/or CSS code) based at least in part on a tag (e.g., a <label> tag). Additionally, or alternatively, the user device may identify the second label as preceding the second input element indicated in the HTML code (and/or the CSS code) based at least in part on a tag (e.g., an <input> tag). Accordingly, the user device may generate the second audio signal based on the second label using the text-to-speech library.

As further shown in FIG. 7, process 700 may include generating, using the speech-to-text library of the web browser, a second transcription of second audio recorded after the second audio signal is played (block 750). For example, the user device (e.g., using processor 620 and/or memory 630) may generate, using the speech-to-text library of the web browser, a second transcription of second audio recorded after the second audio signal is played, as described above in connection with reference numbers 133 and 135 of FIG. 1F. As an example, the second audio may comprise speech with letters. Accordingly, the second transcription may include a transcription of the letters (and optionally any symbols, such as spaces or commas, among other examples). In another example, the second audio may comprise speech with words. Accordingly, the second transcription may include translation of the second audio to corresponding words (e.g., based on phonemes).

As further shown in FIG. 7, process 700 may include modifying the second input element of the web form based on the second transcription (block 760). For example, the user device (e.g., using processor 620 and/or memory 630) may modify the second input element of the web form based on the second transcription, as described above in connection with reference number 137 of FIG. 1G. As an example, the second input element may be a text box, and the user device may insert the second transcription into the second input element. In another example, the second input element may be a drop-down menu or a list of radio buttons, and the user device may select one option, of a plurality of options associated with the second input element, based on the second transcription. For example, the user device may determine that the second transcription matches the option associated with the second input element.

As further shown in FIG. 7, process 700 may include receiving, at the user device, input associated with submitting the web form (block 770). For example, the user device (e.g., using processor 620, memory 630, input component 640, and/or communication component 660) may receive, at the user device, input associated with submitting the web form. As an example, the input may be recorded associated with a submission button, as described in connection with reference numbers 149 and 151 of FIG. 1I. Alternatively, the input may be interaction with the submission button, such as a mouse click, a keyboard entry, or a touchscreen interaction to trigger submission of the web form.

As further shown in FIG. 7, process 700 may include activating a submission element of the web form based on the input (block 780). For example, the user device (e.g., using processor 620 and/or memory 630) may activate a submission element of the web form based on the input, as described above in connection with reference number 153 of FIG. 1J. As an example, the user device may determine that the input matches a command, out of a plurality of possible commands, associated with activating the submission element. In some implementations, the user device may transmit, and a remote server may receive, an indication of the submission of the web form. Additionally, the user device may transmit, and the remote server may receive, information from the modified input elements of the web form. Accordingly, the remote server may receive input based on the transcriptions described herein.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel. The process 700 is an example of one process that may be performed by one or more devices described herein. These one or more devices may perform one or more other processes based on operations described herein, such as the operations described in connection with FIGS. 1A-1J, 2A-2B, 3A-3D and/or 4A-4B. Moreover, while the process 700 has been described in relation to the devices and components of the preceding figures, the process 700 can be performed using alternative, additional, or fewer devices and/or components. Thus, the process 700 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for navigating and completing a web form using audio, the system comprising:
one or more memories; and
one or more processors, communicatively coupled to the one or more memories, configured to:
receive input to trigger audio navigation of a web form loaded by a web browser, wherein the web form comprises hypertext markup language (HTML) code;
generate, using a text-to-speech library of the web browser, a first audio signal based on a first label indicated in the HTML code and associated with a first input element of the web form;
record first audio after generating the first audio signal;
generate, using a speech-to-text library of the web browser, a first transcription of the first audio;
modify the first input element of the web form based on the first transcription;
generate, using the text-to-speech library of the web browser, a second audio signal based on a second label indicated in the HTML code and associated with a second input element of the web form;
record second audio after generating the second audio signal;
generate, using the speech-to-text library of the web browser, a second transcription of the second audio;
modify the second input element of the web form based on the second transcription;
generate, using the text-to-speech library of the web browser, a third audio signal based on a submission button indicated in the HTML code;
record third audio after generating the third audio signal;
generate, using the speech-to-text library of the web browser, a third transcription of the third audio; and
activate the submission button of the web form based on the third transcription.

2. The system of claim 1, wherein the one or more processors are further configured to:
record fourth audio after generating the second audio signal;
generate, using the speech-to-text library of the web browser, a fourth transcription of the fourth audio; and
repeat the second audio signal based on the fourth transcription being associated with a repeat command,
wherein the second audio is recorded after the second audio signal is repeated.

3. The system of claim 1, wherein the one or more processors are further configured to:
record fourth audio after generating the second audio signal;
generate, using the speech-to-text library of the web browser, a fourth transcription of the fourth audio;
repeat the first audio signal based on the fourth transcription being associated with a backward command;
record fifth audio after repeating the first audio signal;
generate, using the speech-to-text library of the web browser, a fifth transcription of the fifth audio; and
re-modify the first input element of the web form based on the fifth transcription.

4. The system of claim 1, wherein the one or more processors are further configured to:
generate, using the text-to-speech library of the web browser, a fourth audio signal based on a third label indicated in the HTML code and associated with a third input element of the web form;
record fourth audio after generating the fourth audio signal;
generate, using the speech-to-text library of the web browser, a fourth transcription of the fourth audio; and
skip the third input element of the web form based on the fourth transcription being associated with a skip command.

5. The system of claim 1, wherein the one or more processors are further configured to:
identify the first label indicated in the HTML code based at least in part on a tag associated with the first input element.

6. The system of claim 1, wherein the one or more processors are further configured to:
identify the submission button indicated in the HTML code based at least in part on a tag associated with the web form.

7. The system of claim 1, wherein the one or more processors are further configured to:
receive an indication of the web form; and
transmit a request for the HTML code using the web browser in response to the indication of the web form.

8. The system of claim 1, wherein the input to trigger audio navigation of the web form is based on a mouse click, a keyboard entry, a touchscreen interaction, or an audio command.

9. A method of navigating and completing a web form using audio, comprising:
generating, by a user device and using a text-to-speech library of a web browser, a first audio signal based on a first label associated with a first input element of a web form;
generating, by the user device and using a speech-to-text library of the web browser, a first transcription of first audio recorded after the first audio signal is played;
modifying the first input element of the web form based on the first transcription;
generating, by the user device and using the text-to-speech library of the web browser, a second audio signal based on a second label associated with a second input element of the web form;
generating, by the user device and using the speech-to-text library of the web browser, a second transcription of second audio recorded after the second audio signal is played;
modifying the second input element of the web form based on the second transcription;
receiving, at the user device, input associated with submitting the web form; and
activating a submission element of the web form based on the input.

10. The method of claim 9, further comprising:
receiving feedback associated with the first audio signal or the second audio signal; and
updating the text-to-speech library based on the feedback.

11. The method of claim 9, wherein the first input element comprises a text box.

12. The method of claim 9, wherein the second input element comprises a drop-down menu or a list of radio buttons, and the second audio signal is further based on a plurality of options associated with the second input element.

13. The method of claim 12, wherein modifying the second input element comprises:
selecting an option, from the plurality of options, based on the second transcription.

14. The method of claim 9, wherein the web form comprises hypertext markup language (HTML) code or cascading style sheets (CSS) code.

15. A non-transitory computer-readable medium storing a set of instructions for navigating and completing a web form using audio, the set of instructions comprising:
one or more instructions that, when executed by one or more processors of a device, cause the device to:
generate, using a text-to-speech library of a web browser, a first audio signal based on a label associated with an input element of a web form;
generate, using a speech-to-text library of the web browser, a first transcription of first audio recorded after the first audio signal is played;
modify the input element of the web form based on the first transcription;
generate, using a speech-to-text library of the web browser, a second transcription of second audio recorded after modifying the input element;
repeat the first audio signal based on the second transcription being associated with a backward command;
generate, using the speech-to-text library of the web browser, a third transcription of third audio recorded after the first audio signal is repeated; and
re-modify the input element of the web form based on the third transcription.

16. The non-transitory computer-readable medium of claim 15, wherein the first audio comprises speech with letters.

17. The non-transitory computer-readable medium of claim 15, wherein the first audio comprises speech with words.

18. The non-transitory computer-readable medium of claim 15, wherein the one or more instructions, that cause the device to modify the input element based on the first transcription, cause the device to:
insert the first transcription into the input element.

19. The non-transitory computer-readable medium of claim 15, wherein the one or more instructions, that cause the device to modify the input element based on the first transcription, cause the device to:
determine that the first transcription matches an option associated with the input element; and
select the option using the input element.

20. The non-transitory computer-readable medium of claim 19, wherein the one or more instructions, that cause the device to determine that the first transcription matches the option, cause the device to:
determine that a similarity score based on the first transcription and the option satisfies a similarity threshold.
